(19) United States
(12) Patent Application Publication
(10) Pub. No.: US 2025/0167574 A1
(43) Pub. Date: May 22, 2025

(54) CHARGING AND DISCHARGING DEVICE AND METHOD FOR CONTROLLING CHARGING AND DISCHARGING

(71) Applicant: Panasonic Intellectual Property Management Co., Ltd., Osaka (JP)

(72) Inventors: Takashi HIGASHIDE, Mie (JP); Katsunori ATAGO, Mie (JP); Youichi KAGEYAMA, Fukushima (JP); Mitsuhiro MATSUO, Osaka (JP); Yugo SETSU, Osaka (JP); Hiroki NISHINAKA, Osaka (JP); Shinichi TANIDA, Osaka (JP); Kazuo TAKENAKA, Osaka (JP)

(73) Assignee: Panasonic Intellectual Property Management Co., Ltd., Osaka (JP)

(21) Appl. No.: 18/836,101

(22) PCT Filed: Dec. 20, 2022
(86) PCT No.: PCT/JP2022/046789

§ 371 Date: Aug. 6, 2024

(30) Foreign Application Priority Data
Feb. 10, 2022 (JP) 2022-019206
Feb. 10, 2022 (JP) 2022-019217
Feb. 10, 2022 (JP) 2022-019225

(51) Int. Cl. H02J 7/00

(52) U.S. Cl. CPC H02J 7/0068; H02J 7/007; H02J 2207/20

(57) ABSTRACT

A charging and discharging device includes: step-up/step-down converter including reference terminals, a first and second input/output terminals; and a power storage element connected between one of the reference terminals and the second input/output terminal, wherein the step-up/step-down converter is a polarity inversion type bidirectional DC-DC converter which charges the power storage element by inverting a polarity of a first DC voltage input from the first input/output terminal using a potential of the reference terminal as a reference potential and stepping up/down the first DC voltage to output a second DC voltage from the second input/output terminal, and discharges the power storage element by inverting a polarity of a third DC voltage input from the second input/output terminal using a potential of the reference terminal as a reference potential and stepping up/down the third DC voltage to output a fourth DC voltage from the first input and input/output terminal.

### TECHNICAL FIELD

The present disclosure relates to a charging and discharging device and a method for controlling charging and discharging of a power storage element by the charging and discharging device, and in particular to a charging and discharging device that performs charging with DC power provided from an external device and supplies the charged DC power to an external device.

### BACKGROUND ART

A charging and discharging device has been proposed as a backup power source that supplies the necessary DC power to on-board equipment in place of the battery when the battery mounted on the vehicle is no longer able to supply DC power. Such a charging and discharging device stores DC power from the battery when the battery is in a charging state, and supplies the charged DC power to the on-board equipment when the battery is no longer able to supply DC power.

Conventionally, an H-bridge step-up and step-down converter that charges/discharges a built-in power storage element is known as a charging and discharging device (see, for example, Patent Literature (PTL) 1). The H-bridge step-up and step-down converter is a DC-DC converter that steps-up/steps-down DC power in both directions.

### CITATION LIST

### Patent Literature

PTL 1: Japanese Unexamined Patent Application Publication No. 2015-42125

### SUMMARY OF INVENTION

### Technical Problem

However, conventional H-bridge step-up and step-down converters require at least four switching elements and a circuit that performs complex control, resulting in problems of a large number of components and a large size.

Therefore, an object of the present disclosure is to provide a charging and discharging device suitable for reducing a size and a method for controlling charging and discharging.

### Solution to Problem

In order to achieve the above object, a charging and discharging device according to one aspect of the present disclosure is a charging and discharging device that performs charging with DC power provided from an external device and supplies the DC power charged to an external device, the charging and discharging device including: a step-up and step-down converter including a reference terminal, a first input and output terminal, and a second input and output terminal; and a power storage element connected between the reference terminal and the second input and output terminal, wherein the step-up and step-down converter is a polarity inversion type bidirectional DC-DC converter which charges the power storage element by inverting a polarity of a first DC voltage input from the first input and output terminal using a potential of the reference terminal as a reference potential and stepping up or stepping down the first DC voltage to output a second DC voltage from the second input and output terminal using the potential of the reference terminal as the reference potential, and discharges the power storage element by inverting a polarity of a third DC voltage input from the second input and output terminal using a potential of the reference terminal as a reference potential and stepping up or stepping down the third DC voltage to output a fourth DC voltage from the first input and output terminal using the potential of the reference terminal as the reference potential.

In order to achieve the above object, a charging and discharging control method according to one aspect of the present disclosure is a method for controlling charging and discharging of a power storage element by a charging and discharging device, the method including: charging the power storage element by converting a first DC voltage into a second DC voltage by inverting a polarity of the first DC voltage that has been input and stepping up or stepping down the first DC voltage, and outputting, to the power storage element, the second DC voltage obtained through the conversion from the first DC voltage; and discharging the power storage element by converting a third DC voltage into a fourth DC voltage by inverting a polarity of the third DC voltage of the power storage element that has been charged, and outputting, to an external device, the fourth DC voltage obtained through the conversion from the third DC voltage.

### Advantageous Effects of Invention

The present disclosure provides a charging and discharging device suitable for reducing a size and a method for controlling charging and discharging.

### BRIEF DESCRIPTION OF DRAWINGS

FIG. 1 is a circuit diagram illustrating the configuration of a charging and discharging device according to Embodiment 1.

FIG. 2 is a flowchart illustrating the operation of the charging and discharging device according to Embodiment 1.

FIG. 3A is a diagram for explaining details of the charging step in FIG. 2.

FIG. 3B is a diagram for explaining details of the discharge step in FIG. 2.

FIG. 4 is a circuit diagram illustrating the configuration of a charging and discharging device according to Embodiment 2.

FIG. 5 is a diagram for explaining the operation of the charging and discharging device according to Embodiment 2.

FIG. 6 is a circuit diagram illustrating the configuration of a charging and discharging device according to Embodiment 3.

FIG. 7 is a diagram for explaining the operation of the charging and discharging device according to Embodiment 3.

### DESCRIPTION OF EMBODIMENTS

Hereinafter, the embodiments of the present disclosure will be described in detail with reference to the drawings. It should be noted that each of the embodiments described below shows a specific example of the present disclosure. The numerical values, shapes, materials, components, arrangement positions and connection forms of the components, steps, order of steps, and the like shown in the following embodiments are merely examples and are not intended to limit the present disclosure. In addition, “A and B are connected” means that A and B are electrically connected, and includes not only a case that A and B are directly connected, but also a case that A and B are indirectly connected with a part connected therebetween. In addition, each figure is not necessarily exactly illustrated. In each figure, substantially the same configuration is given the same reference numeral, and duplicate explanations are omitted or simplified.

### Embodiment 1

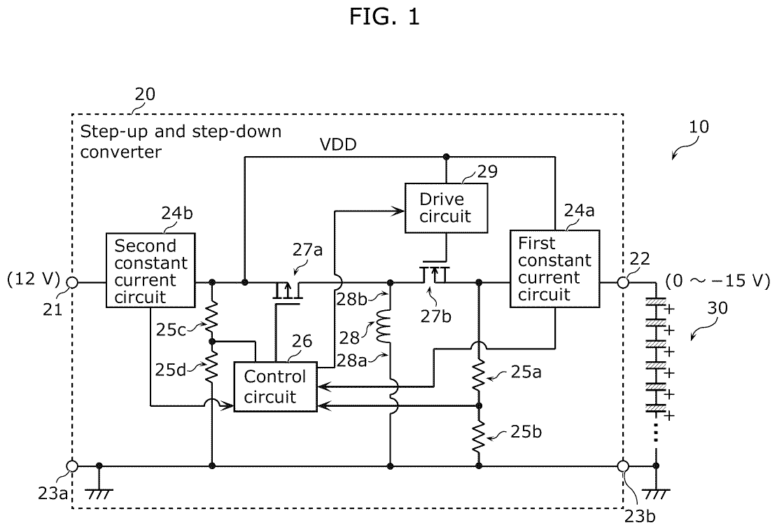

FIG. 1 is a circuit diagram illustrating the configuration of charging and discharging device 10 according to Embodiment 1. Charging and discharging device 10 is a device that performs charging with DC power provided from an external device and supplies the charged DC power to the external device, and is used as a backup power source or the like mounted on a vehicle. Charging and discharging device 10 includes step-up and step-down converter 20 including reference terminals 23a and 23b, first input and output terminal 21, and second input and output terminal 22, and power storage element 30 connected between reference terminal 23b and second input and output terminal 22. It should be noted that reference terminals 23a and 23b are terminals that are connected to a reference potential such as a ground, and may be one common terminal or may be three or more terminals.

Power storage element 30 is a capacitor, and includes, for example, a plurality of electric double layer capacitors connected in series.

Step-up and step-down converter 20 is a polarity inversion type bidirectional DC-DC converter. That is, step-up and step-down converter 20 charges power storage element 30 to a negative voltage by inverting a polarity of a first DC voltage (e.g., 12 V) input from first input and output terminal 21 using a potential of reference terminal 23a as a reference potential and stepping up or stepping down the first DC voltage to output a second DC voltage (e.g., a voltage in the range of 0 to −15 V) from second input and output terminal 22 using the potential of reference terminal 23b as the reference potential. In addition, step-up and step-down converter 20 discharges power storage element 30 by inverting a polarity of a third DC voltage (e.g., a voltage in the range of 0 to −15 V) input from second input and output terminal 22 using a potential of reference terminal 23b as a reference potential and stepping up or stepping down the third DC voltage to output a fourth DC voltage (e.g., 12 V) from first input and output terminal 21 using the potential of reference terminal 23a as the reference potential.

In this way, since step-up and step-down converter 20 is a polarity inversion type bidirectional DC-DC converter, during charging, the potential of second input and output terminal 22 is lower (i.e., negative potential) than the potential of first input and output terminal 21 to which a positive voltage is input, and power storage element 30 can be charged at any voltage (stepped-up or stepped-down voltage), and when power is supplied to the external device, the negative potential charged in power storage element 30 is inverted in polarity and power is supplied to the external device from second input and output terminal 22, and any voltage (stepped-up or stepped-down voltage) with the same polarity as the first DC voltage is supplied to the external device, which makes it possible to realize a smaller number of components than before and reduce the size of charging and discharging device 10.

For this reason, step-up and step-down converter 20 includes as its main components first switch element 27a, inductor 28, and second switch element 27b. Inductor 28 is a choke coil, and includes first terminal 28a connected to reference terminals 23a and 23b (i.e., reference potential), and second terminal 28b. First switch element 27a is a switching element that turns on and off the conduction between first input and output terminal 21 and second terminal 28b of inductor 28, and is, for example, a PMOS transistor. Second switch element 27b is a switching element that turns on and off the conduction between second input and output terminal 22 and second terminal 28b of inductor 28, and is, for example, an NMOS transistor.

Step-up and step-down converter 20 further includes first constant current circuit 24a, second constant current circuit 24b, control circuit 26, drive circuit 29, and resistive elements 25a to 25d.

First constant current circuit 24a is connected between second switch element 27b and second input and output terminal 22, and is a circuit for keeping the current charged to power storage element 30 constant (more specifically, for limiting the maximum value of the charging current flowing therethrough), and is, for example, a resistive element for detecting the charging current. First constant current circuit 24a operates under a supply of the voltage (for example, 12 V) at the source terminal of first switch element 27a as power supply voltage VDD, and outputs a voltage corresponding to the charging current detected here to control circuit 26.

It should be noted that in a conventional charging and discharging device that charges a power storage element with a voltage higher than the input voltage, a separate power supply to supply a voltage higher than the input voltage is required for a constant current circuit that stabilizes the current that charges the power storage element. However, in this embodiment, step-up and step-down converter 20 is a polarity inversion type DC-DC converter and generates a voltage lower than the input voltage (i.e., a negative voltage), so that a separate power supply for first constant current circuit 24a is not required.

Second constant current circuit 24b is connected between first input and output terminal 21 and first switch element 27a, and is a circuit for keeping the current supplied from first input and output terminal 21 to the external device (i.e., the supply current) constant (more specifically, for limiting the maximum value of the supply current flowing therethrough), which is, for example, a resistive element for detecting the supply current. The voltage corresponding to the supply current detected here is input to control circuit 26.

Resistive elements 25a and 25b are connected in series between the connection point between second switch element 27b and first constant current circuit 24a and a reference potential, and are used to monitor the charging voltage of power storage element 30. The divided voltage obtained by resistive elements 25a and 25b is input to control circuit 26. It should be noted that resistive elements 25a and 25b may be connected between second input and output terminal 22 and the reference potential, instead of the connection point between second switch element 27b and first constant current circuit 24a.

Resistive elements 25c and 25d are connected in series between the connection point between second constant current circuit 24b and first switch element 27a and a reference potential, and are used to monitor the voltage (i.e., the supply voltage) supplied to the external device from first input and output terminal 21. The divided voltage obtained by resistive elements 25c and 25d is input to control circuit 26. It should be noted that resistive elements 25c and 25d may be connected between first input and output terminal 21 and the reference potential, instead of the connection point between second constant current circuit 24b and first switch element 27a.

Control circuit 26 is a circuit that outputs drive signals (more specifically, PWM signals) that control on and off and on-duty to first switch element 27a and second switch element 27b in order to perform constant voltage control that keeps the charging voltage of power storage element 30 (i.e., the voltage at second input and output terminal 22) constant, constant voltage control that keeps the DC voltage supplied to the external device (i.e., the supply voltage at first input and output terminal 21) constant, constant current control that keeps the charging current of power storage element 30 constant, constant current control that keeps the DC current supplied to the external device (i.e., the supply current) constant, and switching control that switches between charging and discharging of power storage element 30. Control circuit 26 is, for example, an IC that includes a comparator, a logic circuit, and the like, or an IC that includes a memory that stores a program, a processor that executes the program, an A/D converter, a D/A converter, and the like.

Drive circuit 29 is a circuit that performs level conversion on the drive signal output from control circuit 26 to convert it into a signal suitable for driving second switch element 27b, which is an NMOS transistor, and outputs the signal to the gate terminal of second switch element 27b. Drive circuit 29 operates under a supply of the voltage (e.g., 12 V) at the source terminal of first switch element 27a as power supply voltage VDD.

Next, the operation of charging and discharging device 10 according to Embodiment 1 configured as described above will be described.

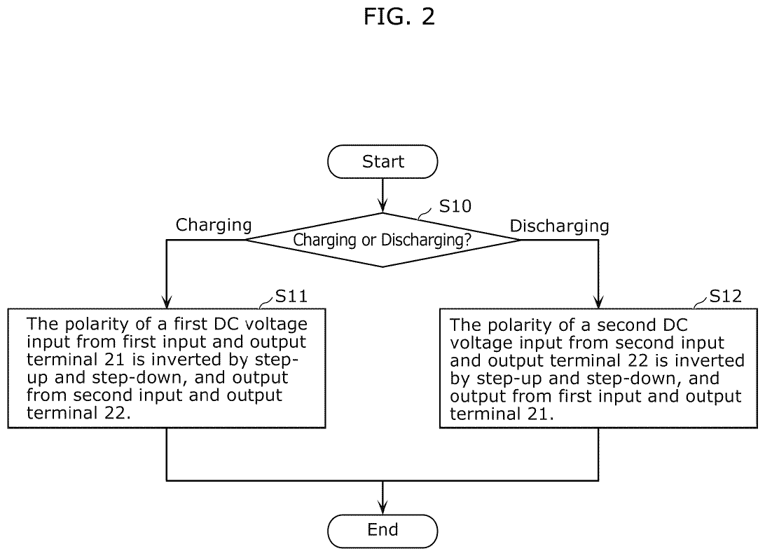

FIG. 2 is a flowchart illustrating the operation of charging and discharging device 10 according to Embodiment 1 (i.e., a method for controlling charging and discharging of power storage element 30 by charging and discharging device 10). Here, the flow of basic control by control circuit 26 is illustrated. When an instruction given from external device via a terminal (not shown) included in control circuit 26 indicates “charging” (“charging” in S10), control circuit 26 controls the on and off of first switch element 27a and second switch element 27b so as to output a negative second DC voltage (e.g., a voltage in the range of 0 to −15 V) from second input and output terminal 22 using the potential of reference terminal 23b as the reference potential by inverting the polarity of the first DC voltage (e.g., 12 V) input from first input and output terminal 21 using the potential of reference terminal 23a as the reference potential, and stepping it up or stepping it down (charging step S11).

On the other hand, when an instruction given from external device via a terminal (not shown) of control circuit 26 indicates “discharging”, which means the supply of DC power to the external device (“discharging” in S10), control circuit 26 controls the on and off of first switch element 27a and second switch element 27b so as to output a positive fourth DC voltage (e.g., 12 V) from first input and output terminal 21 using the potential of reference terminal 23a as the reference potential by inverting the polarity of the negative third DC voltage (e.g., a voltage in the range of 0 to −15 V) input from second input and output terminal 22 using the potential of reference terminal 23b as the reference potential, and stepping it up or stepping it down (discharging step S12).

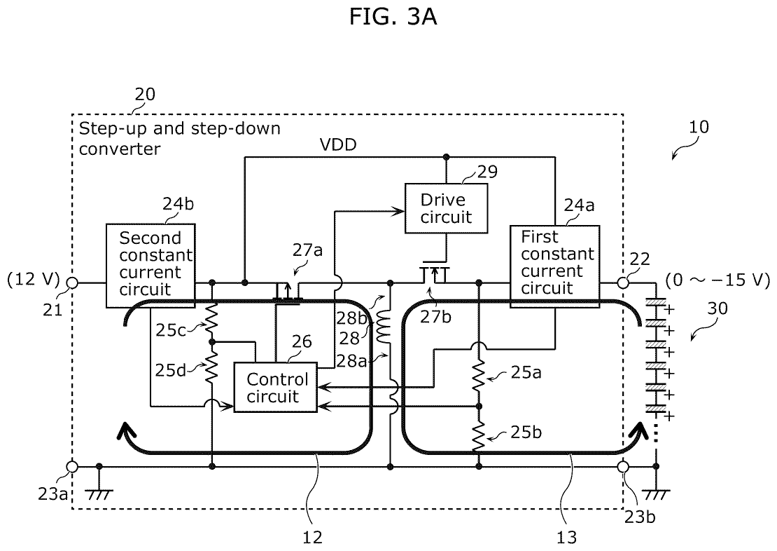

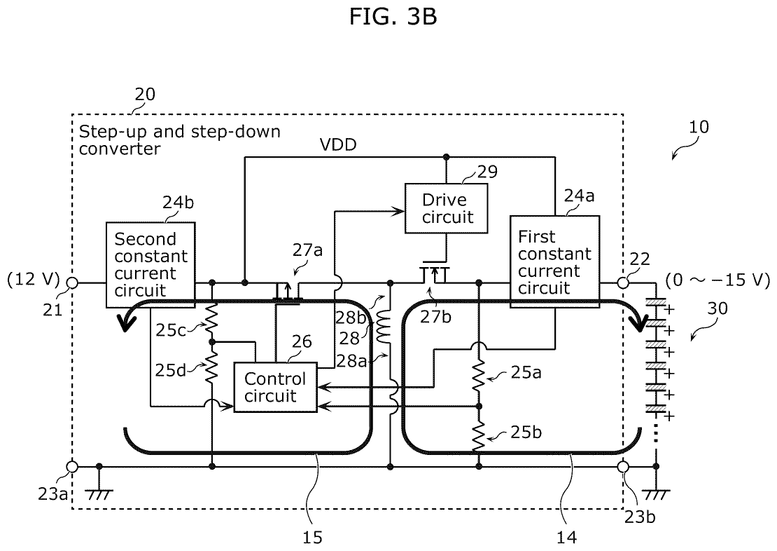

FIG. 3A is a diagram for explaining the details of charging step S11 in FIG. 2. In this figure, currents 12 and 13 that flow during charging in charging and discharging device 10 are illustrated.

Control circuit 26 first turns on first switch element 27a, while keeping second switch element 27b off, to allow current 12 to flow in a loop that runs from first input and output terminal 21 of a positive voltage through second constant current circuit 24b, first switch element 27a, and inductor 28 to reference terminal 23a, thereby storing energy in inductor 28.

Thereafter, by turning off first switch element 27a, control circuit 26 allows the energy stored in inductor 28 to cause current 13 to flow in a loop that runs from first terminal 28a of inductor 28 through reference terminal 23b, power storage element 30, first constant current circuit 24a, and the parasitic body diode of second switch element 27b to second terminal 28b of inductor 28. It should be noted that second switch element 27b may be turned on during the period in which this current 13 is flowing.

In this way, by repeatedly turning first switch element 27a on and off, current 13 flows through power storage element 30 from the lower terminal (the terminal connected to reference terminal 23b) of power storage element 30 to the upper terminal (the terminal connected to second input and output terminal 22), and power storage element 30 is charged with a negative voltage.

FIG. 3B is a diagram for explaining the details of discharging step S12 in FIG. 2. In this figure, currents 14 and 15 that flow during discharging in charging and discharging device 10 are illustrated.

Control circuit 26 first turns on second switch element 27b, while keeping first switch element 27a off, to allow current 14 to flow in a loop that runs from reference terminal 23b, which is the positive voltage terminal of power storage element 30, through inductor 28, second switch element 27b, and first constant current circuit 24a to second input and output terminal 22, which is the negative voltage terminal of power storage element 30, thereby storing energy in inductor 28.

Thereafter, by turning off second switch element 27b, control circuit 26 allows the energy stored in inductor 28 to cause current 15 to flow in a loop that runs from second terminal 28b of inductor 28 through the parasitic body diode included in first switch element 27a, second constant current circuit 24b, first input and output terminal 21, and the load between first input and output terminal 21 and reference terminal 23a to first terminal 28a of inductor 28. It should be noted that first switch element 27a may be turned on during the period in which this current 15 is flowing. In addition, the pulsating voltage at first input and output terminal 21 is smoothed by the capacitance of the load (e.g., a battery) connected between reference terminal 23a and first input and output terminal 21.

In this way, by repeatedly turning second switch element 27b on and off, current 15 is supplied from first input and output terminal 21 to the external device (i.e., a positive voltage is supplied from first input and output terminal 21 to the external device), and power storage element 30 is discharged.

It should be noted that the operation of the constant voltage control that keeps the charging voltage of power storage element 30 (i.e., the voltage at second input and output terminal 22) constant is as follows. That is, during charging, control circuit 26 monitors the divided voltage at the connection point of resistive elements 25a and 25b, and maintains the voltage at second input and output terminal 22 at a predetermined value (for example, a voltage in the range of 0 to −15V) by performing feedback control to control the on-duty of first switch element 27a so that the divided voltage becomes a target value.

In addition, the operation of the constant voltage control that keeps the DC voltage supplied to the external device (i.e., the supply voltage at first input and output terminal 21) constant is as follows. That is, when DC power is supplied to the external device, control circuit 26 monitors the divided voltage at the connection point of resistive elements 25c and 25d, and maintains the supply voltage at first input and output terminal 21 at a predetermined value (e.g., 12 V) by performing feedback control that controls the on-duty of second switch element 27b so that the divided voltage becomes a target value.

In addition, the operation of the constant current control that keeps the charging current of power storage element 30 constant is as follows. That is, during charging, control circuit 26 monitors the voltage corresponding to the charging current detected by first constant current circuit 24a, and when that voltage exceeds a threshold value, control circuit 26 controls the charging current so that it does not exceed a predetermined maximum value by limiting the on-duty of first switch element 27a to a constant value or less so that the voltage does not exceed the threshold value.

In addition, the operation of the constant current control that keeps the DC current supplied to the external device constant is as follows. That is, when DC power is supplied to the external device, control circuit 26 monitors the voltage corresponding to the supply current detected by second constant current circuit 24b, and when that voltage exceeds a threshold value, control circuit 26 controls the supply current so that it does not exceed a predetermined maximum value by limiting the on-duty of second switch element 27b to a constant value or less so that the voltage does not exceed the threshold value.

As described above, charging and discharging device 10 according to Embodiment 1 is a device that performs charging with DC power provided from an external device and supplies the DC power charged to an external device, the charging and discharging device includes: step-up and step-down converter 20 including reference terminals 23a and 23b, first input and output terminal 21, and second input and output terminal 22; and power storage element 30 connected between reference terminal 23b and second input and output terminal 22, wherein step-up and step-down converter 20 is a polarity inversion type bidirectional DC-DC converter, which charges power storage element 30 by inverting a polarity of a first DC voltage input from first input and output terminal 21 using a potential of reference terminal 23a as a reference potential and stepping up or stepping down the first DC voltage to output a second DC voltage from second input and output terminal 22 using the potential of reference terminal 23b as the reference potential, and discharges power storage element 30 by inverting a polarity of a third DC voltage input from second input and output terminal 22 using a potential of reference terminal 23b as a reference potential and stepping up or stepping down the third DC voltage to output a fourth DC voltage from first input and output terminal 21 using the potential of reference terminal 23a as the reference potential.

Accordingly, since step-up and step-down converter 20 includes a polarity inversion type bidirectional DC-DC converter, power storage element 30 can be charged with any voltage (stepped-up or stepped-down voltage) and any voltage (stepped-up or stepped-down voltage) with the same polarity as the first DC voltage can be supplied to the external device, which makes it possible to realize a small number of components and reduce the size of charging and discharging device 10.

Specifically, step-up and step-down converter 20 can include first switch element 27a, inductor 28, and second switch element 27b. In this case, inductor 28 includes first terminal 28a connected to reference terminals 23a and 23b, and second terminal 28b; first switch element 27a turns on and off the conduction between first input and output terminal 21 and second terminal 28b; and second switch element 27b turns on and off the conduction between second input and output terminal 22 and second terminal 28b.

Here, step-up and step-down converter 20 may further include control circuit 26 that controls charging of power storage element 30 by controlling the on and off of first switch element 27a, and controls discharging of power storage element 30 by controlling the on and off of second switch element 27b. This enables constant voltage control and constant current control, which will be described later.

That is, control circuit 26 may control the on-duty of first switch element 27a so that the voltage at second input and output terminal 22 becomes a predetermined value when charging power storage element 30, and may control the on-duty of second switch element 27b so that the voltage at first input and output terminal 21 becomes a predetermined value when supplying DC power to the external device. This enables constant voltage control of the charging voltage and constant voltage control of the voltage supplied to the external device.

In addition, step-up and step-down converter 20 may further include at least one of first constant current circuit 24a for keeping constant a current charged to power storage element 30 when power storage element 30 is charged, or second constant current circuit 24b for keeping constant a current supplied from first input and output terminal 21 to an external device when DC power is supplied to the external device. This enables constant current control of the charging current during charging, and constant current control of the supply current when DC power is supplied to the external device.

In addition, the method for controlling charging and discharging according to Embodiment 1 is a method for controlling charging and discharging of power storage element 30 by charging and discharging device 10, the method including: charging step S11 of charging power storage element 30 by converting a first DC voltage into a second DC voltage by inverting a polarity of the first DC voltage that has been input and stepping up or stepping down the first DC voltage, and outputting, to power storage element 30, the second DC voltage obtained through the conversion from the first DC voltage; and discharging step S12 of discharging power storage element 60 by converting a third DC voltage into a fourth DC voltage by inverting a polarity of the third DC voltage of power storage element 60 that has been charged, and outputting, to an external device, the fourth DC voltage obtained through the conversion from the third DC voltage.

Accordingly, when charging, the polarity inversion type DC-DC converter can charge power storage element 30 at any voltage (stepped-up or stepped-down voltage), and when supplying power to the external device, the polarity inversion type DC-DC converter can supply any voltage (stepped-up or stepped-down voltage) to the external device, so that charging and discharging device 10 can be realized with a small number of components and control is simplified, which makes it possible to reduce the size of charging and discharging device 10.

### Embodiment 2

Next, the charging and discharging device according to Embodiment 2 will be described.

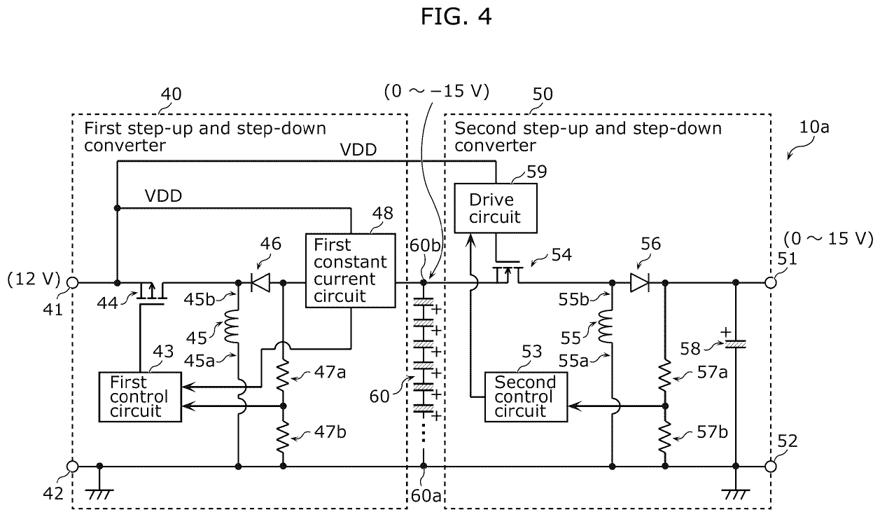

FIG. 4 is a circuit diagram illustrating the configuration of charging and discharging device 10a according to Embodiment 2. Charging and discharging device 10a is a device that performs charging with DC power provided from an external device and supplies the DC power charged to an external device, and is used as a backup power source mounted on a vehicle, or the like. Charging and discharging device 10a includes: power storage element 60, first step-up and step-down converter 40 that charges power storage element 60 to a negative voltage by converting a positive first DC voltage into a negative second DC voltage by inverting a polarity of the positive first DC voltage that has been input from input terminal 41 using a potential of reference terminal 42 as a reference potential and stepping it up or stepping it down, and outputting, to power storage element 60, the negative second DC voltage obtained through the conversion from the positive first DC voltage; and second step-up and step-down converter 50 that discharges power storage element 60 by converting a negative third DC voltage into a positive fourth DC voltage by inverting a polarity of the negative third DC voltage of power storage element 60 that has been charged and stepping it up or stepping it down, and outputting, to the external device from output terminal 51 using a potential of reference terminal 52 as a reference potential, the positive fourth DC voltage obtained through the conversion from the negative third DC voltage.

More specifically, power storage element 60 is a capacitor including first terminal 60a connected to reference terminal 42 (i.e., the reference potential) and second terminal 60b, and includes, for example, a plurality of electric double layer capacitors connected in series.

First step-up and step-down converter 40 includes as its main components first switch element 44, first inductor 45, and first diode 46. First inductor 45 is a choke coil, and includes first terminal 45a connected to a reference potential, and second terminal 45b. First switch element 44 turns on and off the application of the input first DC voltage to second terminal 45b, and is, for example, a PMOS transistor. First diode 46 includes an anode connected to second terminal 60b of power storage element 60, and a cathode connected to second terminal 45b.

First step-up and step-down converter 40 further includes first constant current circuit 48, first control circuit 43, and resistive elements 47a and 47b.

First constant current circuit 48 is connected between the anode of first diode 46 and second terminal 60b of power storage element 60, and is a circuit for keeping the current charged to power storage element 60 constant (more specifically, for limiting the maximum value of the charging current flowing therethrough), and is, for example, a resistive element for detecting the charging current. First constant current circuit 48 operates under a supply of the first DC voltage (for example, 12 V) input to input terminal 41 as power supply voltage VDD, and outputs a voltage corresponding to the charging current detected here to first control circuit 43.

It should be noted that in a conventional charging and discharging device that charges a power storage element with a voltage higher than the input voltage, a separate power supply to supply a voltage higher than the input voltage is required for a constant current circuit that stabilizes the current that charges the power storage element. However, in this embodiment, first step-up and step-down converter 40 is a polarity inversion type DC-DC converter and generates a voltage lower than the input voltage (i.e., a negative voltage), so that a separate power supply for first constant current circuit 48 is not required.

Resistive elements 47a and 47b are connected in series between the anode of first diode 46 and the reference potential, and are used to monitor the charging voltage of power storage element 60. The divided voltage obtained by resistive elements 47a and 47b is input to first control circuit 43. It should be noted that resistive elements 47a and 47b may be connected to both ends of power storage element 60, instead of between the anode of first diode 46 and the reference potential.

First control circuit 43 is a circuit that outputs a drive signal (more specifically, a PWM signal) that controls on and off and on-duty to first switch element 44 in order to perform constant voltage control that keeps the charging voltage of power storage element 60 (i.e., the voltage at second terminal 60b) constant and constant current control that keeps the charging current of power storage element 60 constant. First control circuit 43 is, for example, an IC that includes a comparator, a logic circuit, and the like, or an IC that includes a memory that stores a program, a processor that executes the program, an A/D converter, a D/A converter, and the like.

Second step-up and step-down converter 50 includes as its main components second switch element 54, second inductor 55, and second diode 56. Second inductor 55 is a choke coil, and includes third terminal 55a connected to a reference potential, and fourth terminal 55b. Second switch element 54 turns on and off the application of the charging voltage of power storage element 60 (i.e., the voltage at second terminal 60b) to fourth terminal 55b of second inductor 55, and is, for example, an NMOS transistor. Second diode 56 includes an anode connected to fourth terminal 55b of second inductor 55, and a cathode connected to output terminal 51 for outputting the fourth DC voltage to the external device.

Second step-up and step-down converter 50 further includes second control circuit 53, resistive elements 57a and 57b, drive circuit 59, and smoothing capacitor 58.

Resistive elements 57a and 57b are connected in series between output terminal 51 and reference terminal 52, and are used to monitor the fourth DC voltage (i.e., the voltage at output terminal 51) that is output to the external device. The divided voltage obtained by resistive elements 57a and 57b is input to second control circuit 53.

Second control circuit 53 outputs a drive signal (more specifically, a PWM signal) that controls on and off and on-duty to second switch element 54 via drive circuit 59 in order to perform constant voltage control to keep the voltage output to the external device (i.e., the voltage at output terminal 51) constant based on the divided voltage obtained by resistive elements 57a and 57b. Second control circuit 53 is, for example, an IC that includes a comparator, a logic circuit, and the like, or an IC that includes a memory that stores a program, a processor that executes the program, an A/D converter, a D/A converter, and the like.

Drive circuit 59 is a circuit that performs level conversion on the drive signal output from second control circuit 53 to convert it into a signal suitable for driving second switch element 54, which is an NMOS transistor, and outputs the signal to the gate terminal of second switch element 54. Drive circuit 59 operates under a supply of the first DC voltage (e.g., 12 V) input to input terminal 41 as power supply voltage VDD.

Smoothing capacitor 58 is a capacitor that smooths the pulsating voltage appearing at output terminal 51 using the potential of reference terminal 52 as the reference potential. Next, the operation of charging and discharging device 10a according to Embodiment 2 configured as described above will be described.

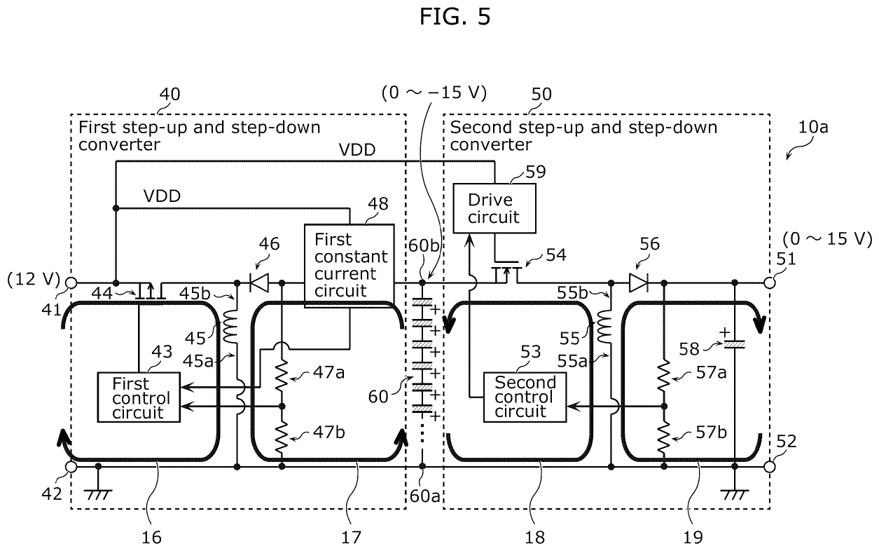

FIG. 5 is a diagram for explaining the operation of charging and discharging device 10a according to Embodiment 2 (i.e., a method for controlling charging and discharging of power storage element 60 by charging and discharging device 10a). Here, first step-up and step-down converter 40 shows currents 16 and 17 that flow during charging, and second step-up and step-down converter 50 shows currents 18 and 19 that flow during discharging.

During charging, first control circuit 43 first turns on first switch element 44 to allow current 16 to flow in a loop that runs from input terminal 41, to which a positive first DC voltage is input, through first switch element 44 and first inductor 45 to reference terminal 42, thereby storing energy in first inductor 45.

Thereafter, by turning off first switch element 44, first control circuit 43 allows the energy stored in first inductor 45 to cause current 17 to flow in a loop that runs from first terminal 45a of first inductor 45 through power storage element 60, first constant current circuit 48, and first diode 46 to second terminal 45b of first inductor 45.

In this way, by repeatedly turning first switch element 44 on and off, current 17 flows through power storage element 60 from first terminal 60a to second terminal 60b of power storage element 60, and power storage element 60 is charged with the second DC voltage, which is a negative voltage. In addition, during charging, first control circuit 43 monitors the voltage at the connection point of resistive elements 47a and 47b, and maintains the voltage (second DC voltage) at second terminal 60b of power storage element 60 at a predetermined value (for example, a voltage in the range of 0 to −15 V) by performing feedback control to control the on-duty of first switch element 44 so that the voltage becomes a target value.

In addition, during charging, first control circuit 43 monitors the voltage corresponding to the charging current detected by first constant current circuit 48, and if that voltage exceeds a threshold value, it controls the charging current so that the charging current does not exceed a predetermined maximum value by limiting the on-duty of first switch element 44 to a certain value or below so that the voltage does not exceed the threshold value.

During discharge, second control circuit 53 first turns on second switch element 54 to allow current 18 to flow in a loop that runs from first terminal 60a, which is the reference terminal of power storage element 60 charged to a negative voltage (third DC voltage), through second inductor 55 and second switch element 54 to second terminal 60b of power storage element 60, thereby storing energy in second inductor 55.

Thereafter, by turning off second switch element 54, second control circuit 53 allows the energy stored in second inductor 55 to cause current 19 to flow in a loop that runs from fourth terminal 55b of second inductor 55 through second diode 56, smoothing capacitor 58, and the load connected between reference terminal 52 and output terminal 51 to third terminal 55a of second inductor 55. It should be noted that the pulsating voltage at output terminal 51 is smoothed by smoothing capacitor 58.

In this way, by repeatedly turning second switch element 54 on and off, current 19 is supplied from output terminal 51 to the external device (i.e., a positive voltage (fourth DC voltage) is supplied from output terminal 51 to the external device), and power storage element 60 is discharged.

In addition, during discharge, second control circuit 53 monitors the voltage at the connection point of resistive elements 57a and 57b, and maintains the voltage (fourth DC voltage) supplied to the external device from output terminal 51 at a predetermined value (for example, a voltage in the range of 0 to 15 V) by performing feedback control to control the on-duty of second switch element 54 so that the voltage becomes a target value.

It should be noted that second step-up and step-down converter 50 may be provided with a constant current circuit for keeping constant the output current supplied from output terminal 51 to the external device. In that case, second control circuit 53 monitors the voltage corresponding to the output current detected by the constant current circuit, and when that voltage exceeds a threshold value, second control circuit 53 controls the output current so that it does not exceed a predetermined maximum value by limiting the on-duty of second switch element 54 to a constant value or less so that the voltage does not exceed the threshold value.

As described above, charging and discharging device 10a of Embodiment 2 is a device that performs charging with DC power provided from an external device and supplies the DC power charged to an external device, the charging and discharging device includes: power storage element 60, first step-up and step-down converter 40 that charges power storage element 60 by converting a first DC voltage into a second DC voltage by inverting a polarity of the first DC voltage that has been input and stepping it up or stepping it down, and outputting, to power storage element 60, the second DC voltage obtained through the conversion from the first DC voltage; and second step-up and step-down converter 50 that discharges power storage element 60 by converting a third DC voltage into a fourth DC voltage by inverting a polarity of the third DC voltage of power storage element 60 that has been charged and stepping it up or stepping it down, and outputting, to the external device, the fourth DC voltage obtained through the conversion from the third DC voltage.

Accordingly, when charging, first step-up and step-down converter 40, which is a polarity inversion type DC-DC converter, charges power storage element 60 with any voltage (stepped-up or stepped-down voltage), and when supplying power to the external device, step-up converter 70, which is a polarity inversion type DC-DC converter, can supply any voltage (stepped-up or stepped-down voltage) with the same polarity as the first DC voltage to the external device, so that charging and discharging device 10a can be realized with a small number of components and control is simplified, which makes it possible to reduce the size of charging and discharging device 10a.

Specifically, first step-up and step-down converter 40 includes first switch element 44, first inductor 45, and first diode 46; first inductor 45 includes first terminal 45a connected to a reference potential, and second terminal 45b; first switch element 44 turns on and off the application of the input first DC voltage to second terminal 45b; first diode 46 includes an anode connected to power storage element 60 and a cathode connected to second terminal 45b;

second step-up and step-down converter 50 includes second switch element 54, second inductor 55, and second diode 56; second inductor 55 includes third terminal 55a connected to a reference potential, and fourth terminal 55b; second switch element 54 turns on and off the application of the charging voltage of power storage element 60 to fourth terminal 55b; and second diode 56 includes an anode connected to fourth terminal 55b, and a cathode connected to output terminal 51 for outputting the fourth DC voltage to the external device.

### Embodiment 3

Next, the charging and discharging device according to Embodiment 3 will be described.

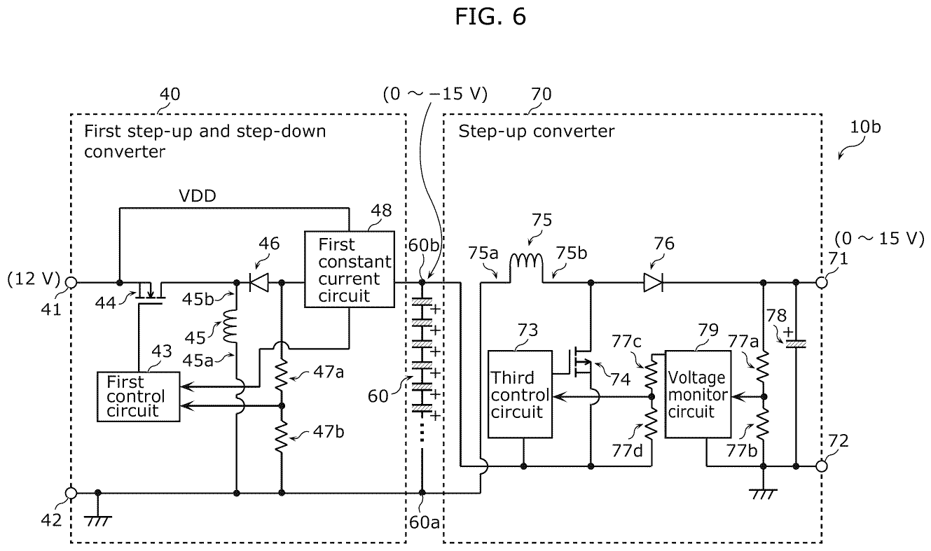

FIG. 6 is a circuit diagram illustrating the configuration of charging and discharging device 10b according to Embodiment 3. Charging and discharging device 10b is a device that performs charging with DC power provided from an external device and supplies the DC power charged to an external device, and is used as a backup power source mounted on a vehicle, or the like. Charging and discharging device 10b includes: power storage element 60; first step-up and step-down converter 40 that charges power storage element 60 by converting a positive first DC voltage into a negative second DC voltage by inverting a polarity of the positive first DC voltage that has been input from input terminal 41 using a potential of reference terminal 42 as a reference potential and stepping it up or stepping it down, and outputting, to power storage element 60, the negative second DC voltage obtained through the conversion from the positive first DC voltage; and step-up converter 70 that discharges power storage element 60 by converting a negative third DC voltage into a positive fifth DC voltage by inverting a polarity of the negative third DC voltage of power storage element 60 that has been charged and stepping it up or down, and outputting, to the external device from output terminal 71 using a potential of reference terminal 72 as a reference potential, the positive fifth DC voltage obtained through the conversion from the negative third DC voltage.

First step-up and step-down converter 40 and power storage element 60 have the same configuration as those in Embodiment 2, and therefore a detailed description thereof will be omitted. However, in this embodiment, an NMOS transistor is shown as a specific example of first switch element 44 included in first step-up and step-down converter 40. It should be noted that first switch element 44 in this embodiment may be a PMOS transistor, as in Embodiment 2.

Step-up converter 70 is a step-up DC-DC converter in which the reference terminal on the input side and the reference terminal on the output side are separated (the electric potentials are insulated), and includes as its main components third switch element 74, third inductor 75, and third diode 76. Third inductor 75 is a choke coil, and includes fifth terminal 75a connected to first terminal 60a (i.e., the reference potential) of power storage element 60, and sixth terminal 75b. Third switch element 74 turns on and off the connection between sixth terminal 75b of third inductor 75 and the reference potential, and is, for example, a PMOS transistor. Third diode 76 includes an anode connected to sixth terminal 75b of third inductor 75, and a cathode connected to output terminal 71 for outputting the fifth DC voltage to the external device.

Step-up converter 70 further includes third control circuit 73, resistive elements 77a and 77b, voltage monitor circuit 79, and smoothing capacitor 78.

Resistive elements 77a and 77b are connected in series between output terminal 71 and reference terminal 72, and are used to monitor the fifth DC voltage (i.e., the voltage at output terminal 71) that is output to the external device. The divided voltage obtained by resistive elements 77a and 77b is input to voltage monitor circuit 79.

Voltage monitor circuit 79 is an isolated voltage transmission circuit, which converts the voltage input to the in terminal using the potential of reference terminal 72 as a reference into a voltage with the potential of second terminal 60b of power storage element 60 as a reference, and outputs the converted voltage from the out terminal, and includes, for example, a photocoupler and the like. Specifically, voltage monitor circuit 79 outputs, from the out terminal, a voltage corresponding to the divided voltage obtained by resistive elements 77a and 77b, which is input to the in terminal. The voltage output from the out terminal is divided by resistive elements 77c and 77d, and the voltage after the division is input to third control circuit 73.

Third control circuit 73 outputs a drive signal (more specifically, a PWM signal) that controls on and off and on-duty to third switch element 74 in order to perform constant voltage control to keep the fifth DC voltage output to the external device (i.e., the voltage at output terminal 71) constant based on the divided voltage obtained by resistive elements 77c and 77d. Third control circuit 73 is, for example, an IC that includes a comparator, a logic circuit, and the like, or an IC that includes a memory that stores a program, a processor that executes the program, an A/D converter, a D/A converter, and the like.

Smoothing capacitor 78 is a capacitor that smooths the pulsating voltage appearing at output terminal 71 using the potential of reference terminal 72 as the reference potential. Next, the operation of charging and discharging device 10b according to Embodiment 3 configured as described above will be described.

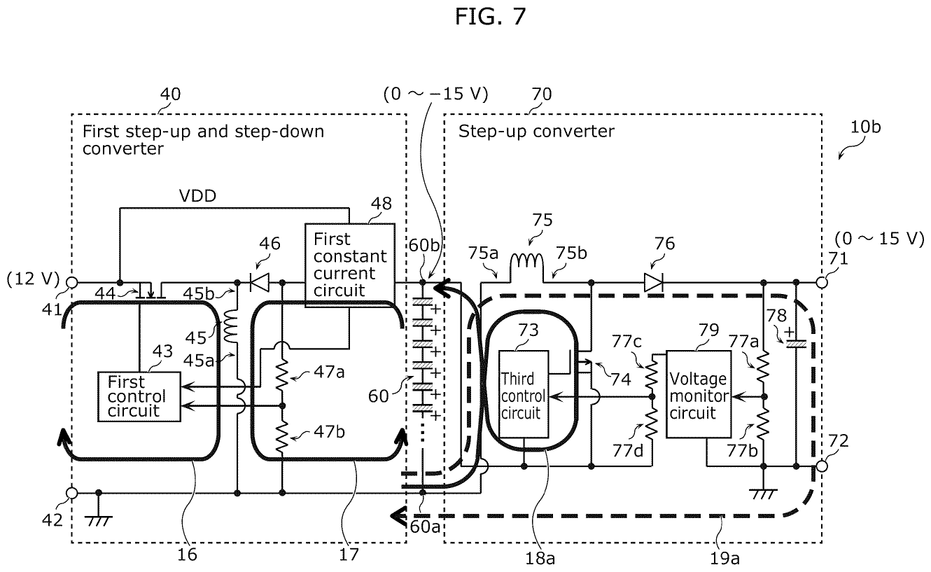

FIG. 7 is a diagram for explaining the operation of charging and discharging device 10b according to Embodiment 3 (i.e., a method for controlling charging and discharging of power storage element 60 by charging and discharging device 10b). Here, first step-up and step-down converter 40 shows currents 16 and 17 that flow during charging, and step-up converter 70 shows currents 18a and 19a that flow during discharging.

It should be noted that since the operation of charging and discharging device 10b during charging is the same as the operation of first step-up and step-down converter 40 of charging and discharging device 10a according to Embodiment 2, the description will be omitted.

During discharging, third control circuit 73 first turns on third switch element 74 to allow current 18a to flow in a loop that runs from first terminal 60a, which is the reference terminal of power storage element 60 charged to a negative voltage (third DC voltage), through third inductor 75 and third switch element 74 to second terminal 60b of power storage element 60, thereby storing energy in third inductor 75.

Thereafter, by turning off third switch element 74, third control circuit 73 allows the energy stored in third inductor 75 to cause current 19a to flow in a loop that runs from sixth terminal 75b of third inductor 75 through third diode 76, smoothing capacitor 78 and the load connected between reference terminal 72 and output terminal 71, and first terminal 60a of power storage element 60 to fifth terminal 75a of third inductor 75. It should be noted that the pulsating voltage at output terminal 71 is smoothed by smoothing capacitor 78.

In this way, by repeatedly turning third switch element 74 on and off, current 19a is supplied from output terminal 71 to the external device (i.e., a positive voltage (fifth DC voltage) is supplied from output terminal 71 to the external device), and power storage element 60 is discharged.

It should be noted that step-up converter 70 may be provided with a constant current circuit for keeping constant the output current supplied from output terminal 71 to the external device. In that case, third control circuit 73 monitors the voltage corresponding to the output current detected by the constant current circuit, and when the voltage exceeds a threshold value, third control circuit 73 controls the output current so that it does not exceed a predetermined maximum value by limiting the on-duty of third switch element 74 to a constant value or less so that the voltage does not exceed the threshold value.

As described above, charging and discharging device 10b according to Embodiment 3 is charging and discharging device 10b that performs charging with DC power provided from an external device and supplies the DC power charged to an external device, the charging and discharging device includes: power storage element 60; first step-up and step-down converter 40 that charges power storage element 60 by converting a first DC voltage into a second DC voltage by inverting a polarity of the first DC voltage that has been input and stepping it up or stepping it down, and outputting, to power storage element 60, the second DC voltage obtained through the conversion from the first DC voltage; and step-up converter 70 that discharges power storage element 60 by converting a third DC voltage into a fifth DC voltage by inverting a polarity of the third DC voltage of power storage element 60 that has been charged and stepping it up, and outputting, to the external device, the fifth DC voltage obtained through the conversion from the third DC voltage.

Accordingly, when charging, first step-up and step-down converter 40, which is a polarity inversion type DC-DC converter, charges power storage element 60 with any voltage (stepped-up or stepped-down voltage), and when supplying power to the external device, step-up converter 70, which is a polarity inversion type DC-DC converter, can supply any voltage (stepped-up voltage) with the same polarity as the first DC voltage to the external device, so that charging and discharging device 10b can be realized with a small number of components and control is simplified, which makes it possible to reduce the size of charging and discharging device 10b.

Specifically, first step-up and step-down converter 40 includes first switch element 44, first inductor 45, and first diode 46; first inductor 45 includes first terminal 45a connected to a reference potential, and second terminal 45b; first switch element 44 turns on and off the application of the input first DC voltage to second terminal 45b; first diode 46 includes an anode connected to power storage element 60 and a cathode connected to second terminal 45b; the step-up converter includes third inductor 75, a third switch element, and third diode 76; third inductor 75 includes fifth terminal 75a connected to a reference potential, and sixth terminal 75b; the third switch element turns on and off the connection between sixth terminal 75b and the reference potential; and third diode 76 includes an anode connected to sixth terminal 75b, and a cathode connected to output terminal 71 for outputting the fifth DC voltage to the external device.

The charging and discharging device and the method for controlling charging and discharging according to the present disclosure have been described above based on Embodiments 1 to 3, but the present disclosure is not limited to these Embodiments 1 to 3. forms obtained by applying various modifications to each embodiment conceived by a person skilled in the art or forms constructed by combining parts of the components in each embodiment without departing from the spirit of the present disclosure are also included within the scope of this disclosure.

For example, in the above embodiments, charging and discharging device 10 or the like is a device used as a backup power source mounted on a vehicle, but the application is not limited thereto. It can be used as a device that performs charging with DC power provided from an external device and supplies the charged DC power to the external device, and as a power source that supplies DC power to all kinds of equipment and vehicles.

In addition, in the above embodiments, the first DC voltage input to charging and discharging device 10 or the like is a positive voltage, but it may be a negative voltage. In that case, during charging, the polarity of the negative input voltage is inverted and power storage element 30 or the like are charged with the positive voltage, and during discharging, the polarity of the positive voltage charged to power storage element 30 or the like is inverted and supplied to the external device as a negative voltage.

In addition, in the above embodiments, the DC-DC converter is provided with a constant voltage circuit, a constant current circuit, and a control circuit that controls them, but the constant voltage circuit, the constant current circuit, and the control circuit are optional components. That is, in cases where constant voltage control and constant current control are not required, where an external control circuit is provided, or the like, the constant voltage circuit, the constant current circuit, and the control circuit may not necessarily be provided in the charging and discharging device. A charging and discharging device suitable for reducing a size can be realized by a charging and discharging device provided with two polarity inversion type DC-DC converters.

### INDUSTRIAL APPLICABILITY

The present disclosure can be used as a charging and discharging device, in particular, as a charging and discharging device suitable for reducing a size, for example, as a backup power source for batteries mounted on vehicles.

### REFERENCE SIGNS LIST

10, 10a, 10b Charging and discharging device
20 Step-up and step-down converter
21 First input and output terminal
22 Second input and output terminal
23a, 23b, 42, 52, 72 Reference terminal
24a, 48 First constant current circuit
24b Second constant current circuit
25a-25d, 47a, 47b, 57a, 57b, 77a-77d Resistance element
26 Control circuit
27a, 44 First switch element
27b, 54 Second switch element
28 Inductor
28a, 45a, 60a First terminal
28b, 45b, 60b Second terminal
29, 59 Drive circuit
30, 60 Power storage element
40 First step-up and step-down converter
41 Input terminal
43 First control circuit
45 First inductor
46 First diode
50 Second step-up and step-down converter
51, 71 Output terminal
53 Second control circuit
55 Second inductor
55a Third terminal
55b Fourth terminal
56 Second diode
58, 78 Smoothing capacitor
70 Step-up converter
73 Third control circuit
74 Third switch element
75 Third inductor
75a Fifth terminal
75b Sixth terminal
76 Third diode
79 Voltage monitor circuit

1. A charging and discharging device that performs charging with DC power provided from an external device and supplies the DC power charged to an external device, the charging and discharging device comprising:
a step-up and step-down converter including a reference terminal, a first input and output terminal, and a second input and output terminal; and
a power storage element connected between the reference terminal and the second input and output terminal,
wherein the step-up and step-down converter is a polarity inversion type bidirectional DC-DC converter which
charges the power storage element by inverting a polarity of a first DC voltage input from the first input and output terminal using a potential of the reference terminal as a reference potential and stepping up or stepping down the first DC voltage to output a second DC voltage from the second input and output terminal using the potential of the reference terminal as the reference potential, and
discharges the power storage element by inverting a polarity of a third DC voltage input from the second input and output terminal using a potential of the reference terminal as a reference potential and stepping up or stepping down the third DC voltage to output a fourth DC voltage from the first input and output terminal using the potential of the reference terminal as the reference potential.

2. The charging and discharging device according to claim 1,
wherein the step-up and step-down converter includes a first switch element, an inductor, and a second switch element,
the inductor includes a first terminal connected to the reference terminal, and a second terminal,
the first switch element turns on and off conduction between the first input and output terminal and the second terminal, and
the second switch element turns on and off conduction between the second input and output terminal and the second terminal.

3. The charging and discharging device according to claim 2,
wherein the step-up and step-down converter further includes a control circuit that controls charging to the power storage element by controlling on and off of the first switch element, and controls discharging from the power storage element by controlling on and off of the second switch element.

4. The charging and discharging device according to claim 3,
wherein the control circuit controls on-duty of the first switch element for a voltage of the second input and output terminal to be a predetermined value when the power storage element is charged.

5. The charging and discharging device according to claim 3,
wherein the control circuit controls on-duty of the second switch element for a voltage of the first input and output terminal to be a predetermined value when DC power is supplied to an external device.

6. The charging and discharging device according to claim 1,
wherein the step-up and step-down converter further includes at least one of a first constant current circuit for keeping constant a current charged to the power storage element when the power storage element is charged, or a second constant current circuit for keeping constant a current supplied from the first input and output terminal to an external device when DC power is supplied to the external device.

7. A charging and discharging device that performs charging with DC power provided from an external device and supplies the DC power charged to an external device, the charging and discharging device comprising:
a power storage element;
a first step-up and step-down converter that charges the power storage element by converting a first DC voltage into a second DC voltage by inverting a polarity of the first DC voltage that has been input and stepping up or stepping down the first DC voltage, and outputting, to the power storage element, the second DC voltage obtained through the conversion from the first DC voltage; and
a second step-up and step-down converter that discharges the power storage element by converting a third DC voltage into a fourth DC voltage by inverting a polarity of the third DC voltage of the power storage element that has been charged and stepping up or stepping down the third DC voltage, and outputting, to the external device, the fourth DC voltage obtained through the conversion from the third DC voltage.

8. The charging and discharging device according to claim 7,
wherein the first step-up and step-down converter includes a first switch element, a first inductor, and a first diode,
the first inductor includes a first terminal connected to a reference potential, and a second terminal,
the first switch element turns on and off application of the first DC voltage input to the second terminal,
the first diode includes an anode connected to the power storage element, and a cathode connected to the second terminal,
the second step-up and step-down converter includes a second switch element, a second inductor, and a second diode,
the second inductor includes a third terminal connected to a reference potential, and a fourth terminal,
the second switch element turns on and off application of a charging voltage of the power storage element to the fourth terminal, and
the second diode includes an anode connected to the fourth terminal, and a cathode connected to a terminal for outputting the fourth DC voltage to the external device.

9. A charging and discharging device that performs charging with DC power provided from an external device and supplies the DC power charged to an external device, the charging and discharging device comprising:
a power storage element;
a first step-up and step-down converter that charges the power storage element by converting a first DC voltage into a second DC voltage by inverting a polarity of the first DC voltage that has been input and stepping up or stepping down the first DC voltage, and outputting, to the power storage element, the second DC voltage obtained through the conversion from the first DC voltage; and
a step-up converter that discharges the power storage element by converting a third DC voltage into a fifth DC voltage by inverting a polarity of the third DC voltage of the power storage element that has been charged and stepping up the third DC voltage, and outputting, to the power storage element, the fifth DC voltage obtained through the conversion from the third DC voltage.

10. The charging and discharging device according to claim 9,
wherein the first step-up and step-down converter includes a first switch element, a first inductor, and a first diode,
the first inductor includes a first terminal connected to a reference potential, and a second terminal,
the first switch element turns on and off application of the first DC voltage input to the second terminal,
the first diode includes an anode connected to the power storage element, and a cathode connected to the second terminal,
the step-up converter includes a third inductor, a third switch element, and a third diode,
the third inductor includes a fifth terminal connected to a reference potential, and a sixth terminal,
the third switch element turns on and off a connection between the sixth terminal and the reference potential, and
the third diode includes an anode connected to the sixth terminal, and a cathode connected to a terminal for outputting the fifth DC voltage to the external device.

11. A method for controlling charging and discharging of a power storage element by a charging and discharging device, the method comprising:
charging the power storage element by converting a first DC voltage into a second DC voltage by inverting a polarity of the first DC voltage that has been input and stepping up or stepping down the first DC voltage, and outputting, to the power storage element, the second DC voltage obtained through the conversion from the first DC voltage; and
discharging the power storage element by converting a third DC voltage into a fourth DC voltage by inverting a polarity of the third DC voltage of the power storage element that has been charged, and outputting, to an external device, the fourth DC voltage obtained through the conversion from the third DC voltage.
